(19) United States
(12) Patent Application Publication
(10) Pub. No.: US 2012/0148717 A1
(43) Pub. Date: Jun. 14, 2012

(54) MULTIVITAMIN COMPOSITION

(76) Inventor: Steven R. Sponder, Boca Raton, FL (US)

(21) Appl. No.: 13/349,787

(22) Filed: Mar. 5, 2012

Related U.S. Application Data
(63) Continuation-in-part of application No. 12/806,324, filed on Aug. 10, 2010.
(60) Provisional application No. 61/274,492, filed on Aug. 17, 2009.

(51) Int. Cl. A23L 1/302; A23L 2/52; A23L 1/304

(52) U.S. Cl. 426/311; 426/648

(57) ABSTRACT

A multivitamin composition is delivered as a taste-neutral and clearly dissolving powder for addition to various beverages and food products during the manufacturing process. The formula of the multivitamin composition provides selected essential vitamins and minerals. The powder contains one or more buffered and pH neutral vitamins to assist in achieving the taste-neutral and clearly dissolving characteristics of the composition. The granulated particles of vitamins and minerals may be micro-encapsulated to help conceal the taste of the vitamins and minerals.

### BACKGROUND OF THE INVENTION

This application is a Continuation-In-Part application based on non-provisional patent application Ser. No. 12/806,324 filed on Aug. 10, 2010, which is based on provisional patent application Ser. No. 61/274,492 filed on Aug. 17, 2009.

### FIELD OF THE INVENTION

The present invention relates to nutritional supplements and, more particularly, to a multivitamin and multi-mineral composition delivered as a taste-neutral and clearly dissolving powder.

### DISCUSSION OF THE RELATED ART

Vitamins and minerals, referred to as multivitamins, provide a supplement of important nutrients to a consumer's diet. Reasons for using a multivitamin may vary from dietary imbalances to pregnancy, however the most common use of multivitamins is to supplement a normal diet to supply any important vitamins that a consumer may not have received throughout their day. Rising healthcare costs have caused an increase in multivitamin consumption, since many health problems can be caused by vitamin deficiencies. Most multivitamins are sold as containers of pills to be taken once per day, however these pills are usually quite expensive and many consumers are not willing to pay the high price for them. Even for those who can afford multivitamins, there are several downsides associated with taking a multivitamin such as the inconvenience of having to take a pill every day and the bad aftertaste following a pill.

In view of the shortcomings associated with existing methods for delivering multivitamins, there remains a need for a multivitamin fortifying ingredient deliverable as a taste-neutral and clearly dissolving powder which is convenient for adding to the ingredients of beverages or food products during the manufacturing process or by the user prior to consuming the beverage or food product.

### OBJECTS AND ADVANTAGES OF THE INVENTION

Considering the foregoing, it is a primary object of the present invention to provide a multivitamin composition in the form of a generally taste-neutral and clearly dissolving powder which can be added to the ingredients of a beverage or food product to provide a daily supplement of vitamins and minerals upon consumption.

It is a further object of the present invention to provide a multivitamin composition in the form of a taste-neutral and clearly dissolving powder, as described above, which uses micro-encapsulation of particles to help achieve the taste-neutral characteristic.

It is a further object of the present invention to provide a multivitamin composition in the form of a taste-neutral and clearly dissolving powder, as described above, which includes selected near-pH neutral ingredients to help achieve the taste-neutral characteristic.

It is still a further object of the present invention to provide a multivitamin composition in the form of a powder substance that quickly dissolves into a beverage or food product without altering the color or flavor of the beverage or food product.

It is still a further object of the present invention to provide a multivitamin composition in the form of a powder or granulated substance that can be easily combined with a natural or artificial sweetener in the same package (e.g., a paper sachet or packet) so that an end user can conveniently enhance their food or beverage with a taste-free (i.e. taste neutral) multivitamin when adding a sweetener.

These and other objects and advantages of the present invention are more readily apparent with reference to the detailed description.

### SUMMARY OF THE INVENTION

The present invention is directed to a multivitamin composition in the form of a taste-neutral and clearly dissolving powder which may be added as a vitamin fortifying ingredient to various beverages and food products during the manufacturing process or by a user prior to consuming the beverage or food product. One or more of the vitamins in the formula are micro-encapsulated to conceal the flavor of the vitamins and buffered to be pH neutral to assist in achieving the taste-neutral and clearly dissolving characteristics of the composition. It has been discovered that by buffering the pH of the vitamin ingredients so that the vitamin ingredients and the entire composition have a pH of between 6.5 and 7.5, and preferably between 6.8 and 7.2, the taste of the composition is significantly diminished to the extent that the taste is not detectable when consumed. In this sense, the vitamin composition is considered to be taste neutral.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view illustrating the poly-lined packet for storing a single dose of the multivitamin composition of the present invention.

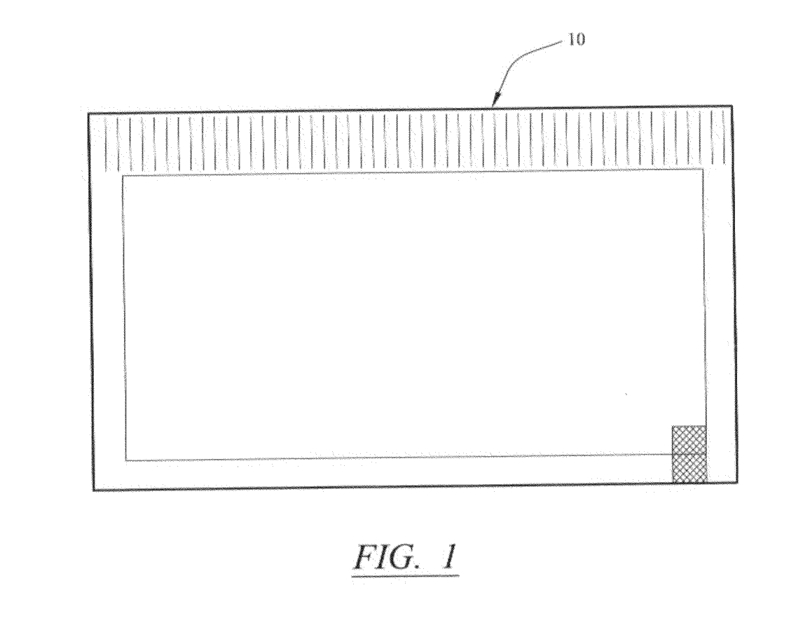

### DETAILED DESCRIPTION OF THE PRESENT INVENTION

A formula for a daily multivitamin and multi-mineral mixture provides selected essential vitamins and minerals in the form of a taste-neutral and clearly dissolving powder which may be added as a vitamin fortifying ingredient to various beverages and food products during the manufacturing process. Alternatively, the multivitamin composition may be provided in an approximately one gram serving sized packet 10, such as a paper sachet or stick, which may be mixed into a beverage or food product by a user prior to consuming the beverage or food product. The inner surfaces of the packets 10 are poly-coated to protect the powder composition from moisture. The vitamins and minerals of the formula are micro-encapsulated to conceal the taste of the vitamins and minerals, and pH buffered to form a taste-neutral and clearly dissolving powder which provides the full benefit of the vitamins and minerals upon consumption of the beverage or food product without affecting the taste or color of the product. The multivitamin composition dissolves taste-neutral in products such as breads, cereals, chips, crackers, dressings, drink mixes, ground coffee, instant coffee, jelly, juices, milk, mustard, pasta, peanut butter, pet foods, rice, salad dressings, sauces, spices, sugars, sweetener packets, water, yogurt, and other beverages and food products.

Several embodiments of the multivitamin fortifying composition have been considered. In a first embodiment, the multivitamin fortifying composition includes Vitamin C, Thiamin (Vitamin B1), and Pantothenic Acid which have been appropriately buffered to be pH neutralized (pH at or near 7.0). It has been discovered that by buffering the pH of the vitamin ingredients so that the resultant composition has a pH of between 6.5 and 7.5, and preferably between 6.8 and 7.2, the multivitamin composition becomes taste-neutral. In another embodiment, the multivitamin fortifying composition includes Vitamins C, A, B1, B3, B5, B6, B7, B12, D, E, and K which have been pH neutralized. Other vitamin powder combinations provided in a taste-neutral and clearly dissolving powder may be utilized to develop a multivitamin composition as well.

The multivitamin composition of the present invention is substantially taste-neutral, clearly dissolving and may be non-sweetened, thereby accompanying existing food and beverage products without changing the flavor, color, or other characteristics of the products to which it is added. It is further contemplated that the taste-neutral multivitamin composition of the present invention can be combined with a natural or artificial sweetener.

A bitter blocker, such as adenosine 5′-monophosphate, may be included in the multivitamin composition to help in achieving the taste-neutral characteristic. The bitter blocker has the effect of inhibiting bitterness by acting directly on a subset of bitter taste receptors in an individual's mouth, limiting the individual's ability to detect the bitterness of an ingredient.

The vitamin product of the present invention may be sold in bulk to beverage and food product manufacturers and providers as an additive, for example, manufacturers of natural and artificial sweeteners, thereby making it a cost-effective tool to help attract customers who are interested in an alternative to the traditional means of taking vitamins in pill form. Because many consumers prefer to take a multivitamin supplement on a daily basis, but do not want to pay the high price for multivitamin pills or liquid formulations, inclusion of a taste-neutral multivitamin within a beverage or food product is an ideal solution. This taste-neutral multivitamin delivery method will allow retailers to offer vitamin enhanced products to consumers without changing the flavor or appearance of their existing products.

The following is an example of the formula of the composition, including daily value percentages, of the present invention:

### EXAMPLE

| Ingredient Name | Daily Value |
|---|---|
| Vitamin C | 25% DV |
| (for example: Calcium Ascorbate and/or Ascorbic Acid) | |
| Vitamin D (for example: Cholecalciferol) | 20% DV |
| Vitamin B6 (for example: Pyridoxal-5-Phosphate) | 10% DV |
| Vitamin B12 (for example: Cyanocobalamin) | 20% DV |
| Zinc (for example: Zinc Gluconate) | 5% DV |

Additional ingredients include dextrose (limits bitterness), maltodextrin (limits sweetness), and silica (prevents caking of composition).

Consumers will prefer the present invention to alternative methods of taking a daily multivitamin because the product of the present invention is more convenient than having to swallow a pill, and it has no bitter or unpleasant aftertaste.

While the present invention has been shown in accordance with a preferred and practical embodiment, it is recognized that departures from the instant disclosure are fully contemplated within the spirit and scope of the present invention as set forth in the following claims as interpreted under the doctrine of equivalents.

What is claimed is:

1. A vitamin composition for fortifying a beverage or food product with one or more vitamins and minerals, said vitamin composition comprising:
a granulated powder containing one or more vitamins and minerals and each of said one or more vitamins and minerals being buffered to have a pH between 6.5 and 7.5 to diminish the taste of the one or more vitamins and minerals in the vitamin composition, and said vitamin composition being colorless when dissolved in the beverage or food product.

2. The vitamin composition as recited in claim 1, wherein at least some granulated particles of the one or more vitamins and minerals are micro-encapsulated to conceal the taste of the one or more vitamins and minerals.

3. The vitamin composition as recited in claim 1 further comprising a natural sweetener.

4. The vitamin composition as recited in claim 1 further comprising an artificial sweetener.

5. The vitamin composition as recited in claim 1 further comprising a bitter blocker.

6. The vitamin composition as recited in claim 1 further comprising a packet for storing and delivering a single dose of said vitamin composition.

7. A method of fortifying a beverage or food product with vitamins comprising the steps of:
selecting one or more vitamins and minerals and combining the one or more vitamins and minerals in a vitamin composition, and the selected one or more vitamins and minerals being buffered to have a pH of between 6.5 and 7.5 to diminish the taste of the one or more vitamins and minerals in the vitamin composition;
providing the vitamin composition in granulated powder form;
packaging the granulated powder vitamin composition in a single serving packet; and
delivering a single serving dosage of the vitamin composition to a user by opening the single serving packet and adding the granulated powder vitamin composition to the beverage or food product.

8. The method of fortifying a beverage or food product with vitamins as recited in claim 7, further comprising the step of:
micro-encapsulating at least some granulated particles of the one or more vitamins and minerals to conceal the taste of the one or more vitamins and minerals.

9. The method of fortifying a beverage or food product with vitamins as recited in claim 6 further comprising the step of:
adding a natural sweetener to the granulated vitamin powder composition.

10. The method of fortifying a beverage or food product with vitamins as recited in claim 6 further comprising the step of:
adding an artificial sweetener to the granulated vitamin powder composition.

11. The method of fortifying a beverage or food product with vitamins as recited in claim 6 further comprising the step of:
adding a bitter blocker to the granulated vitamin powder composition.

12. A vitamin composition for fortifying a beverage or food product with one or more vitamins and minerals, said vitamin composition comprising:
a granulated powder containing one or more vitamins and minerals and each of said one or more vitamins and minerals being buffered to have a pH between 6.5 and 7.5 to diminish the taste of the one or more vitamins and minerals in the vitamin composition, and said vitamin composition being colorless when dissolved in the beverage or food product; and
wherein at least some granulated particles of the one or more vitamins and minerals are micro-encapsulated to conceal the taste of the one or more vitamins and minerals.

13. The vitamin composition as recited in claim 12 further comprising a natural sweetener.

14. The vitamin composition as recited in claim 12 further comprising an artificial sweetener.

15. The vitamin composition as recited in claim 12 further comprising a bitter blocker.

16. The vitamin composition as recited in claim 12 further comprising a packet for storing and delivering a single dose of said vitamin composition.
